(19) United States
(12) Patent Application Publication
(10) Pub. No.: US 2006/0216214 A1
(43) Pub. Date: Sep. 28, 2006

(54) Method and apparatus for dispersing Aerosol agents

(76) Inventors: Robert C. Brown, Arlington, TX (US); Justin R. Brown, Arlington, TX (US)

Correspondence Address: CHALKER FLORES, LLP, 2711 LBJ FRWY, Suite 1036, DALLAS, TX, 75234, US

(21) Appl. No.: 11/082,317

(22) Filed: Mar. 17, 2005

(51) Int. Cl. B60H 3/02; B60H 3/00

(52) U.S. Cl. 422/124; 422/123; 454/157

(57) ABSTRACT

The present invention includes a device, method and system for positioning an agent delivery device wherein the agent delivery device includes a pivotable container holder with a generally planar base, one or more supports extending generally perpendicular from the generally planar base, a container holding portion having a container aperture for fitting frictionally a container and one or more stops extending from the base, wherein the one or more stops restrict the movement of the container.

### TECHNICAL FIELD OF THE INVENTION

The present invention relates generally to treating air circulation systems, and in particular, to a device for positioning a deodorization delivery system and/or a container within a generally enclosed area without damaging the surrounding enclosure.

### BACKGROUND OF THE INVENTION

Without limiting the scope of the invention, its background is described in connection with devices to position a container within an area or enclosure, as an example.

The main purpose of a ventilation system (e.g., heating, ventilating and air conditioning) is to provide the inside of an enclosure with comfortable, clean and odor-free air. Most ventilation systems share common components whether in a vehicle or a building. Commonly, ventilation systems include a duct system to transport the air to different locations, a fan to circulate the air, an air outlet and an inlet to bring fresh air into the enclosure or for recirculation of the air. Many ventilation systems include heating and cooling components such as heating coils, condensers and compressors. These heating and cooling components alter the humidity and temperature of the air being transported.

As the ventilation system operates, air and any contaminants suspended in the air are transported into the ventilation system. These contaminants (e.g., mold spores, microbes, bacteria, chemicals and dust) may be deposited on the surfaces within the ventilation system; and this accumulation may lead to many problems. Whether it is a vehicle or a building, the warm moisture humid environment of the ventilation system can result in bacterial or microbial growth and an unusual dank, musty odor emanating from the ventilation system.

A variety of mechanisms have been developed to mask or eliminating odors emanating from the ventilation system of an enclosure (e.g., buildings, rooms and vehicles), however, such known mechanisms are expensive, generally difficult to manufacture and are generally intended for permanent use within the system of the enclosure. For example, a fragrance supplying device for ventilation systems that eliminates unpleasant odors through emitting pleasant fragrances is commercially available; however, it is often difficult to maintain a pleasant atmosphere over a long period. A number of commercial systems introduce agents directly into the ventilation system through the ventilation ducts; however, this results in the need for retrofitting the existing ventilation system and complicated control systems.

U.S. Pat. No. 5,833,929 to Watson, et al., relates to an automatic air freshener and deodorizer for releasing a scent into an interior of a vehicle. The device includes a pump disposed within a housing, the housing is positioned within a trunk of a vehicle and the pump has wiring extending outwardly therefrom. The housing has an opening extending within a top wall thereof and is in communication with the pump. The opening receives an air fragrance canister has an outlet pipe connected to an inlet tube of the pump. The pump has an outlet tube directed outwardly of the housing. A tube extends outwardly of the outlet tube of the pump that extends into a bifurcated outer portion with open ends. The bifurcated outer portion is positionable beneath seats of the vehicle. However, the system only positions generally the output of the device and it does not allow the agents to be delivered into the ventilation system.

Another factor that complicates delivery of agents into ventilation systems is the placement of the intake system. The air intake area of many ventilation systems is positioned in awkward locations, e.g., under the dash of a car or in a closet of a building. The present systems cannot deliver the agents to the desired location and do not maximize the distribution of the agents. For example, many dispensing units are placed on the floor and at best disperse the contents in the general direction. Therefore, the intake areas are not accessible to the released agents. The agents are released in a localized area and allowed to diffuse into the enclosure and eventually be pulled into the intake area. As a consequence of the positioning of the dispensing units there is often a high concentration of the dispensed agent in the areas adjacent to the dispensing units, which can lead to localized deposits of the agent on the adjacent surfaces, e.g., floors, doors walls, carpet, seats, dashs and the like. The localized deposition of agents reduces the concentration of agent that is actually introduced into the ventilation system and create other problems due to the accumulation of agents in one area (e.g., cleanup). Although the art discloses a variety of systems for delivering agents to ventilation system, none of the systems provide a device to position the dispensing unit to more effectively despise the agent.

The foregoing problems have been recognized for many years and while numerous solutions have been proposed, none of them adequately address all of the problems in a single device, e.g., inexpensive positioning device for efficient agent delivery to a specific location.

### SUMMARY OF THE INVENTION

The present inventors recognized a need for a deodorizing system positioning device that would accommodate various different dispensing unit positions, while allowing effective delivery to the agent into the ventilation system enclosed area without damaging the surrounding enclosure. In accordance with the present invention, a method, device and system are provided that accommodates various alignments for receiving a dispensing container, while allowing effective directional delivery to an agent into a ventilation system or enclosure.

The pivotable container holder of the present invention has numerous uses and applications where positioning containers and directing delivery of compounds is critical. For example, the pivotable container holder can be used to directing the delivery of a deodorization compound in a container to an area in need of deodorizing. The pivotable container holder can also be used to direct the delivery of a fragrance into an area or onto a surface or in a direction to maximize the distribution of the fragrance.

Other embodiments of the present invention may be used to position container to direct the delivery of the contents to a specific location. For example, the pivotable container holder can be used to direct the delivery of paint onto a surface or an area. The pivotable container holder can be used to position a container to direct the delivery of a visible indicator (e.g., fog, colored smoke, colored liquids or a combination thereof) onto an air current to chart air paths, e.g., race car design, plane design, car design, spaceship design, bicycle design, vehicle aerodynamics and similar studies. The pivotable container holder may be used to disperse the contents onto the walls of an enclosure, e.g., a container containing a flame retardant is placed into a container holder and positioned with in an enclosure so that the contents are dispersed throughout the enclosure.

The enclosure may be a sealed enclosure having one or more sidewalls, a top and a bottom or unsealed enclosure having one or more wall. Furthermore, the enclosure may also be an area, e.g., a lot of land, a yard, a pasture, a dock, a roof top or similar area. The enclosure may include a car, a house, a building, an office, a closet, a room, an attic, a crawl space, a cab, a tool box, a refrigerator, a freezer, a trailer, a trunk, a bus, a trolley, a mobile home, a bathroom, a bedroom, a garage, a warehouse, a storage unit, a clubhouse, a pantry, a laundry, a shed, a kitchen, a toy box, a train, an RV, an airplane, a helicopter, boat or a combination thereof.

For example, the present invention provides a method, system and device for deodorizing vehicle malodors by inserting a container having a deodorizing compound into a container holder having a container holding portion connected to one or more supports extending generally perpendicular from a generally planar base and one or more stops extending from the generally planar base, wherein the one or more stops restrict the movement of the container, adjusting the container to the desired position and activating the container, whereby the agent is dispersed. The position may be adjusted by placing the container holder on the floor, rotating the container in the container holder portion to provide the desired coverage and rotating the angle of the container holder portion relative to the base and securing the container holder portion with one or more stops.

The present invention includes a pivotable container holder having a generally planar base, one or more supports extending generally perpendicular from the generally planar base, a container holding portion having a container aperture for fitting frictionally, the container being attached pivotably to one or more of the one or more supports and one or more angled stops extending from the base, wherein the one or more stops restrict the movement of the container.

Another example of the present invention includes a method of delivering an agent into an enclosure including the steps of inserting a container into a container holder having a container holding portion connected to one or more supports extending generally perpendicular from a generally planar base and one or more stops extending from the generally planar base, wherein the one or more stops restrict the movement of the container, adjusting the container to the desired position and activating the container.

The present invention also includes a method of positioning an agent delivery device including the steps of inserting a container into a container holder having a container holding portion connected to one or more supports extending generally perpendicular from a generally planar base and one or more stops extending from the generally planar base, wherein the one or more stops restrict the movement of the container and adjusting the container holder to the desired position.

Still another example of the present invention includes an agent dispersion system that includes a generally planar base, one or more supports extending generally perpendicular from the generally planar base, a container holding portion having a container aperture attached pivotably to one or more of the one or more supports, one or more stops extending from the base, wherein the one or more stops restrict the movement of the container and a container for fitting frictionally to the container aperture.

### BRIEF DESCRIPTION OF THE DRAWINGS

For a more complete understanding of the features and advantages of the present invention, reference is now made to the detailed description of the invention along with the accompanying figures and in which:

FIGS. 1 and 2 illustrate certain features of a delivery unit positioning device according to an embodiment of the present invention in operation;

FIG. 3 is a side view of an embodiment of a portion of the device shown in FIG. 1;

FIG. 4 is a side view of another embodiment of a portion of the device shown in FIG. 1;

FIG. 5 is a front view of an embodiment of a portion of the device shown in FIG. 1;

FIG. 6 is a top view of an embodiment of a portion of the device shown in FIG. 1;

FIG. 7 is a side view of an embodiment of a portion of the device shown in FIG. 1;

FIG. 8 is a front view of an embodiment of a portion of the device shown in FIG. 1;

FIG. 9 is a top view of an embodiment of a portion of the device shown in FIG. 1;

FIG. 10 is a side view of one embodiment of the device shown in FIG. 1;

FIG. 11 is a back view of one embodiment of the device shown in FIG. 1;

FIG. 12 is a top view of one embodiment of the device shown in FIG. 1; and

FIG. 13 is a side view of one embodiment of the device shown in FIG. 1 in operation.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The terminology used and specific embodiments discussed herein are merely illustrative of specific ways to make and use the invention and do not delimit the scope of the invention.

In accordance with the present invention, a method, system and device are provided for the deodorizing a vehicle by inserting a container having a deodorizing compound into a container holder having a container holding portion connected to one or more supports extending generally perpendicular from a generally planar base and one or more stops extending from the generally planar base, wherein the one or more stops restrict the movement of the container, adjusting the container to the desired position and activating the container, whereby the agent is dispersed. The position may be adjusted by placing the container holder on the floor, rotating the container in the container holder portion to provide the desired coverage and adjusting the angle of the container holder portion relative to the base and securing the container holder portion with one or more stops.

The present invention provides a method, system and device that supply a stable base and position a container to facilitate the distribution of its contents in a directional manner. For example, the pivotable container holder of the present invention is designed as a device for positioning a container so that the delivery of the contents of the container is in a directional manner. The method, device and system of the pivotable container holder of the present invention are designed to facilitate the delivery of the contents of a container into the ducts of a ventilation system; however, the present invention may also be used to deliver an agent into an enclosure. The enclosure may be a room, a part of a room, a wall, the space behind a wall, an attic or similar enclosure. The pivotable container holder of the present invention allows adjustment of the angle the container is held and the position of the delivery mechanism, e.g., nozzle, tube or tip.

The pivotable container holder of the present invention includes a generally planar base, one or more supports extending generally perpendicular from the base, a container holding portion having a container aperture for fitting frictionally a container attached pivotably to one or more of the one or more supports and one or more stops extending from the base, wherein the one or more stops restrict the movement of the container. This configuration allows the container to be positioned at the desired angle to accommodate dispersion into an enclosure and induction into a ventilation system while increasing stability using a base and reducing the damage to the surrounding enclosure.

The present invention also includes a method of delivering an agent into an enclosure by inserting a container into a container holder having a container holding portion connected to one or more supports extending generally perpendicular from a generally planar base and one or more stops extending from the generally planar base, wherein the one or more stops restrict the movement of the container, adjusting the container to the desired position and activating the container, so that the contents are released.

The present invention also includes a method of positioning an agent delivery device by inserting a container into a container holder having a container holding portion connected to one or more supports extending generally perpendicular from a generally planar base and one or more stops extending from the generally planar base, wherein the one or more stops restrict the movement of the container and adjusting the container holder to the desired position.

In one embodiment the one or more supports further include one or more apertures and the container holding portion further includes one or more tangentially extending tabs, wherein the one or more apertures receive pivotably the one or more tangentially extending tabs. Furthermore, the base may include a coating or surface that aids in the positioning of the pivotable container holder through the addition of a non-slip bottom surface, a tacky surface, a magnetic surface, a hook and loop surface, a glued surface, a surface a metal surface or combinations thereof. The base may also include one or more weights or be weighted itself to further add stability to the container holder. The weights may be connected through an attachment mechanism (e.g., peg and hole, tape, adhesive, hook and loop structure, epoxy, weld, solder or similar mechanism known in the art), through simple friction or integrated into the device or the container.

The pivotable container holder may be made from a variety of materials, e.g., metal, alloy, plastic, composite materials, carbon-fiber, ceramics, glass, rock, stone, wood, rubber, plastic, latex, vinyl, polymers or a combination thereof. Furthermore, the pivotable container holder may be constructed from a single material or multiple different materials. For example, the container stand may include a generally planar base constructed of plastic and a first support and/or the second support constructed from metal. Alternatively, the container stand base may be constructed metal and a first support and/or the second support constructed from a plastic, and the container holder portion may be made from rubber. A person of ordinary skill in the art will recognize the endless number of materials that may be used to make the present invention and the unlimited combinations of different materials that may be used to construct the individual components of the device.

Furthermore, the pivotable container holder may be constructed through a variety of fabrication procedures, due in part to the material being used to construct the pivotable container holder. For example, the pivotable container holder may be molded form a plastic, metal, alloy, composite, or thermoplastic material either in individually components or as a single unit. The pivotable container holder may also be cast or poured from metals, alloys, plasters, compositions, composites, glasses, thermoplastics and the like. The pivotable container holder may be machined from rock, granite, natural stone, marble, metal, alloy, wood or similar materials. A person of ordinary skill in the art will recognize that other methods may be used to construct the pivotable container holder either as a whole or in part, whereby one or more of the components or made using different procedures.

The present invention is designed to fit containers that deliver agents in a variety of different manners, including spraying, misting, fogging, smoking, atomizing, dispersing, evaporating, diffusing, coating, sputtering, propelling or combinations thereof. The agents may take any convenient form including liquids, solids, gases, foams, gels, or combinations thereof. The contents of the container may be dispersed through a variety of different methods. The container may be an aerosol container, a spray container, a pump container, a container connected to an external pressure supply, a pressurized container, a container and fan combination or a combination thereof.

The container may be of different shapes and sizes. The most common container shape is a cylindrical, however, other shapes may be used such as spherical, conical, rectangular, polygonal or a combination thereof. The container holder may be designed to accommodate container of the common size, e.g., 4, 6, 8, 10, 12 18, 20 and 24 ounces. Additionally, the container may be designed to fit relatively small containers with volumes equivalents measured in ounces to larger volumes containers with equivalent volumes measured in gallons. The container holder may be fitted with an adaptor that accommodates container of different sizes.

Furthermore, the agents that may be delivered include odor neutralizing compounds, insecticides, fragrances, perfumes, soaps, detergents, disinfectants, sterigents, bactericides, alcohols, paints, fogs, colored dyes, gases, oxidizing agents, reducing agents, fungicides, virucides, acid-based foams, riot control agents (e.g., pepper spray, tear gas and mace), waterproofing agents, release agent or coating in high temperature processes (e.g., Boron Nitride), polyurethane foam, polymer foams, colloid systems of continuous liquid phase and a discontinuous gas or vapor phase.

The present invention allows the container to be adjusted to a variety of angles, form 90 degrees to 0 degrees relative to the base. In container holders that position a container at an angle that is not relatively perpendicular to the base, the center of gravity of the container holder fitted with the container must be considered to ensure stability. Generally, the center of gravity is a geometric property of the object defined as the average location of the weight of an object and dictates the rotation of the object. An object that is tilted will be stable as long as the center of gravity lies inside the supporting base of the object. Similarly, a suspended object will remain stable as long as the center of gravity lies below the point of suspension.

The pivotable container holder of the present invention maintains the center of gravity generally inside the base supporting the container and at or below the point of suspension (e.g., the connection between the container stand and the container holder portion), thus, maintaining the stability of the pivotable container holder when fitted with a container. The size and shape of the base may be selected to match the container and retain favorable center of gravity properties. The base may be round, oval, square, rectangular, polygonal, triangular or a combination thereof. The base may be elongated on one end, both ends, one side, both sides or a combination thereof to maintain the center of gravity within the base.

In addition to different shaped bases, the height and width of the supports to may be adjusted to maintain the center of gravity below the point of suspension. The adjustments may include different container holders matched to different containers, container holders that have extendable/retractable supports and bases that are extendable/retractable to maintain the center of gravity within the desired parameters to maintain stability. Furthermore, the container holder portion may be connected to the supports at different heights to maintain the center of gravity. Some embodiments include supports having multiple positions each spaced at different heights for connecting the container, whereby the location of the container may be changed.

The container holder portion may also have a variety of diameters depending on the particular container to be fitted therein. The distance from one wall to another (e.g., radius) may be adjusted to fit different container. Additionally, the distance between the top of the container holder sidewall and the container holder bottom or floor may be different depending on the particular application, thereby adjusting the center of gravity relative to the connection point. Another method to alter the center of gravity relative to the connection point is to place connection extensions between the container holder portion and the support, to effectively lower the center of gravity relative to the connection point. Alternatively, the container holder may be adjusted through the addition of expanders which attach to the container holder to expand the length of the supports and/or the diameter of the base.

The pivotable container holder of the present invention allows the positioning of a container in multiple dimensions to facilitate the delivery of the contents in a directional manner. The pivoting of the container holder along with the rotation of the container within the container holder portion allows the container to be adjusted to maximize the delivery of the contents. Additionally, the pivotable container holder can be adjusted to deliver the substance toward, onto or away from a particular surface or area.

For example, the container may be used to disperse a deodorizing compound into the interior of a vehicle. The container holder may be positioned at about a 45 degree angle relative to the generally planar base and the container rotated to point the nozzle away from the seats and transmission tunnel, thereby reducing the accumulation of deodorizing compound on the surfaces of the interior. Alternatively, when the container is used for the distribution of fragrances into a room, the container holder may be positioned at about a 45 to 90 degree angle relative to the generally planar base and the container rotated to point the nozzle toward the ceiling; thus, maximizing the distribution area of the fragrances. In another example, the container holder may position the container to maximize the uptake of the container contents, e.g., liquid containers that have an internal pickup tube that regulates the flow.

The pivotable container holder of the present invention has numerous uses and applications where positioning containers and directing delivery of compounds is critical. For example, the pivotable container holder can be used to directing the delivery of a deodorization compound in a container to an area in need of deodorizing. The pivotable container holder can also be used to direct the delivery of a fragrance into an area or onto a surface or in a direction to maximize the distribution of the fragrance. The pivotable container holder can be used to direct the delivery of paint onto a surface or an area. The pivotable container holder can be used to position a container to direct the delivery of a visiable indicator (e.g., fog, colored smoke, colored liquids or a combination thereof) onto an air current to chart air paths, e.g., race car design, plane design, car design, spaceship design, bicycle design, vehicle aerodynamics and similar studies. The pivotable container holder may be used to disperse the contents onto the walls of an enclosure. For example, a container containing a flame retardant is placed into a container holder and positioned with in an enclosure so that the contents are dispersed throughout the enclosure.

The enclosure may include a car, a house, a building, an office, a closet, a room, an attic, a crawl space, a cab, a tool box, a refrigerator, a freezer, a trailer, a trunk, a bus, a trolley, a mobile home, a bathroom, a bedroom, a garage, a warehouse, a storage unit, a clubhouse, a pantry, a laundry, a shed, a kitchen, a toy box, a train, an RV, an airplane, a helicopter, boat or a combination thereof.

In some embodiments, the container holding portion is generally circular and the one or more supports have one or more apertures and the container holding portion has one or more tangentially extending tabs, wherein the one or more aperture receive pivotably the one or more tangentially extending tabs. The present invention also includes adjusting the angle of the container holding portion relative to the generally planar base and/or adjusting the container comprises rotating the container within the container holding portion. Thus, allowing the contents of the container to be delivered within an enclosure.

The present invention also includes an agent dispersion system having a generally planar base, one or more supports extending generally perpendicular from the generally planar base, a container holding portion having a container aperture attached pivotably to one or more of the one or more supports, a container for fitting frictionally to the container aperture and one or more stops extending from the base, wherein the one or more stops restrict the movement of the container.

The one or more stops may be generally perpendicular to the base and extend to a height that is necessary to secure the container. The one or more stops may be individually of different sizes and shapes, e.g., bar, square, rectangle, circle, cone, oval, triangular polygonal or a combination thereof. Furthermore, the one or more stops may include a mechanism (e.g., plastic tab, magnetic portion, barb, clip, tacky region, slot, groove, notch, hook, recess or a combination thereof) that may interact with the container or the container holder to prevent movement. The one or more stops may be positioned on the base a different locations and at different heights to allow different angles. Alternatively, the base may include one or more apertures into which one or more stops may be inserted, thus forming a universal base that may be fitted with stops of different heights, shapes and sizes to accommodate containers and supports of different dimensions.

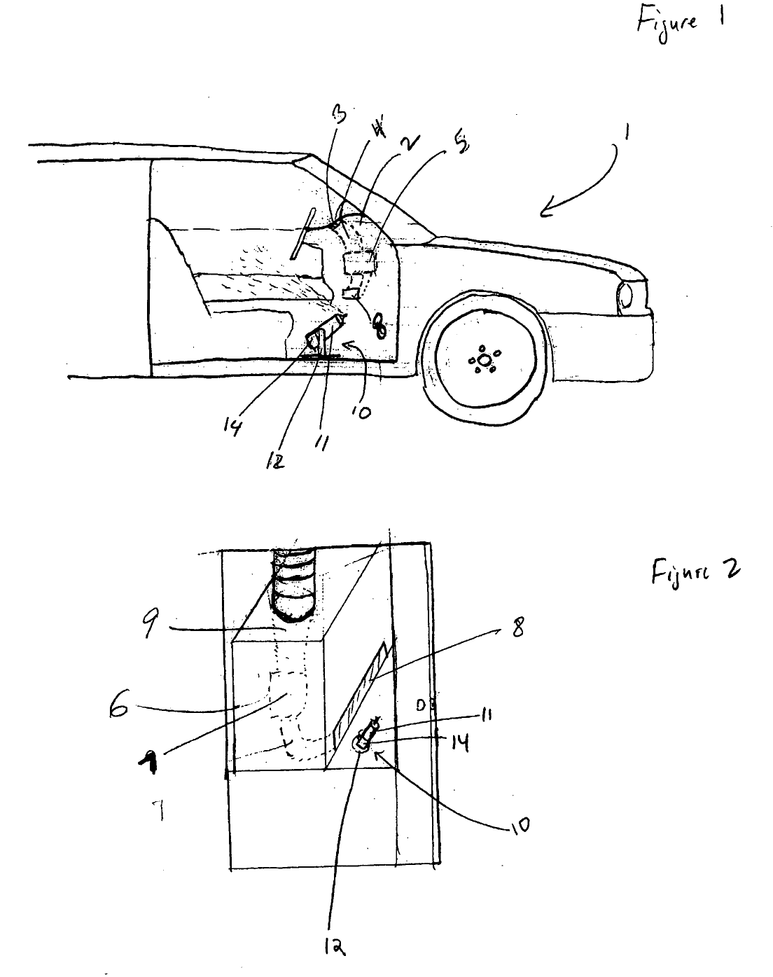

With reference to FIGS. 1 and 2 views of different embodiment of the pivotable container holder in operation. FIG. 1 illustrates the ventilation system of a vehicle 1. The dashboard 2 of the vehicle 1 contains one or more vents 3, which receive air from the duct 4 as air is pushed by blower motor 5. The ventilation system intake 8 is located at the bottom of the dashboard 2 and supplies air to the blower motor 5. FIG. 1 depicts a ventilation system intake 8 and the pivotable container holder 10 fitted with a container 11 for delivery of agents in a directional manner in a vehicle 1. The pivotable container holder 10 includes a container stand 12 and a container holder 14. The pivotable container holder 10 is positioned on the floor of the vehicle 1 and the position of the container 11 adjusted so that the delivery is directed into the enclosure to maximize the distribution of the contents, while minimizing the accumulation on surfaces (e.g., seats, dash, carpet, transmission tunnel and the like) and the ventilation system intake 8. Through adjusting the angle the container 11 relative to the floor of the vehicle 1 and rotating the container 11 within the container holder 10 the output of the container 11 can be directed into the enclosure to maximize the distribution of the contents, while minimizing the accumulation on surfaces (e.g., seats, dash, carpet, transmission tunnel and the like) and the ventilation system intake 8. Furthermore, the container 11 can be left unattended in the vehicle 1 without worry of movement of the container 11 during operation.

FIG. 2 depicts the pivotable container holder 10 fitted with a container 11 for delivery of agents in a directional manner positioned adjacent to the intake system 8 of a home ventilation system 6. The home ventilation system 6 contains the ducts 9 which receive air from the blower 7. The ventilation system intake 8 is located at the bottom of the home ventilation system 6 and supplies air to the blower 7. The pivotable container holder 10 includes a container stand 12 and a container holder 14. The pivotable container holder 10 is positioned adjacent to the intake system 8 of the ventilation unit. The angle may be adjusted relative to the floor of the enclosure and the container rotated within the container holder 10 allowing the output of the container 11 to be directed into the enclosure to maximize the distribution of the contents, while minimizing the accumulation on surfaces (e.g., wall, side of the ventilation system, carpet, door, and the like) and the ventilation system intake 8. Furthermore, the container 11 can be left unattended in the enclosure without worry of movement of the container during operation.

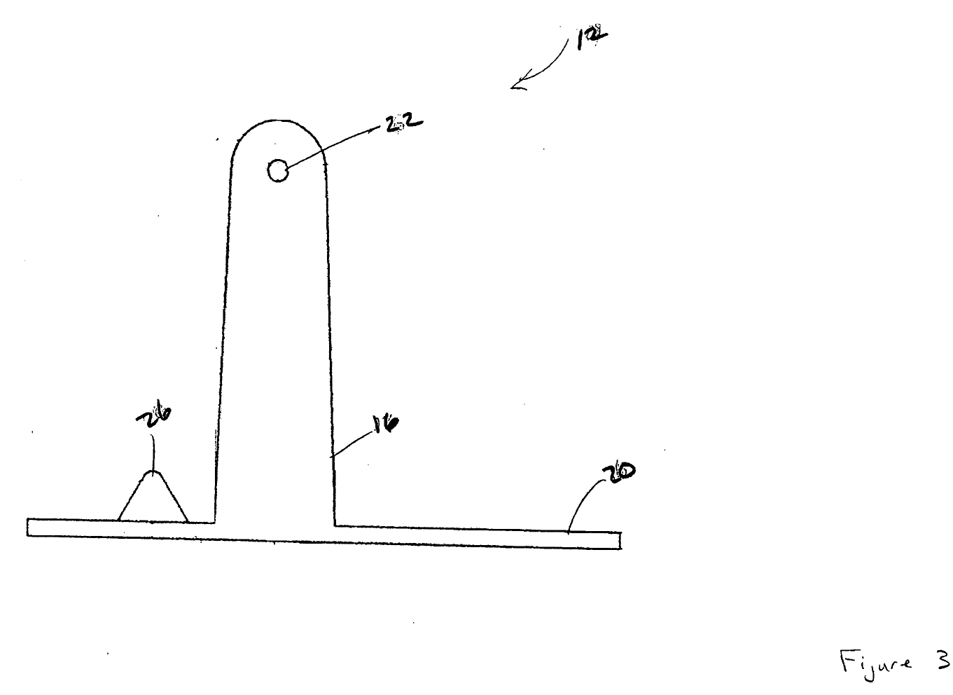

With reference to FIG. 3, a container stand 12, in accordance with the present invention is shown and includes a first support 16 extending generally perpendicular from the base 20. The first support 16 has a first aperture 22 extending through the first support 16. In other embodiments, the first aperture 22 may extend partially through the first support 16. One or more stops 26 are disposed on or about the base 20, wherein the one or more stops 26 impede the motion of the container (not shown).

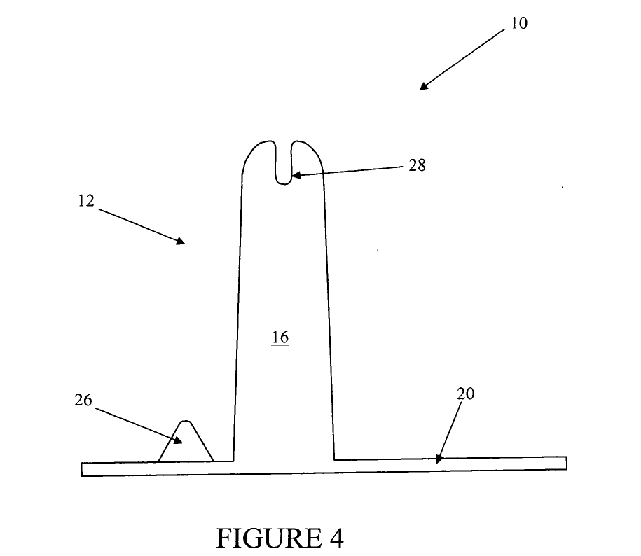

With reference to FIG. 4, a container stand 12, in accordance with another embodiment of the present invention is shown and includes a first support 16 extending generally perpendicular from the base 20. The first support 16 has a first notch 28 extending partially into the first support 16. The first notch 28 may be positioned at one end of the first support 16 or along a portion of the first support 16. Additionally, the first notch 28 may be a series of two or more notches (not shown) positioned at intervals along the first support 16, to provide a range of mounting positions to accommodate different containers (not shown) and conditions. One or more stops 26 are disposed on or about the base 20, wherein the one or more stops 26 impede the motion of the container (not shown).

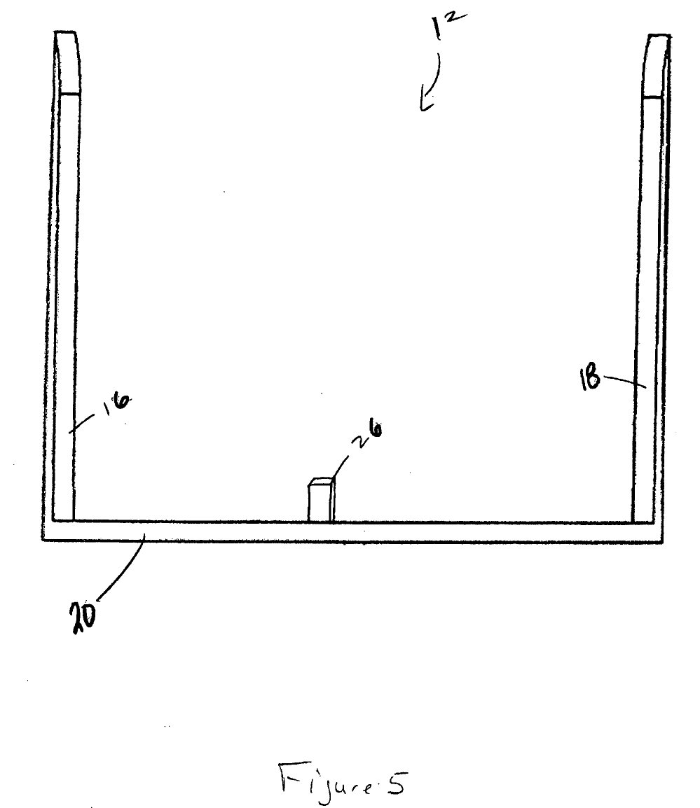

FIG. 5 is a front view of a portion of an embodiment of the device shown in FIG. 1. The container stand 12 includes a first support 16 and a second support 18 extending generally perpendicular from the base 20. One or more stops 26 are disposed on or about the base 20, wherein the one or more stops 26 impede the motion of the container (not shown).

The pivotable container holder 10 may be made from a variety of materials, e.g., metal, alloy, plastic, composite materials, carbon fiber, ceramics, glass, rock, stone, wood or a combination thereof. Furthermore, the pivotable container holder 10 may be constructed from a single material or multiple materials. For example, the container stand 12 may include the base 20 constructed of plastic and the first support 16 and/or the second support 18 constructed from metal. The pivotable container holder 10 may be molded, poured or machined to create the desired shape. The pivotable container holder 10 may be constructed using other methods known to the persons of ordinary skill in the art.

The container stand 12 of the present invention may have a first support 16 and a second support 18 extending generally perpendicular from the base 20. In some embodiments, the container stand 12 may have only a first supports 16; however, in other embodiments the container stand 12 may have a first support 16 and a second support 18. The container stand 12 may also have more than two supports (not shown) depending on the particular needs of the application.

The first support 16 and the second support 18 are positioned generally perpendicular to the base 20. The first support 16 and the second support 18 may be positioned at angles that are not perpendicular to the base depending on the particular application. For example, the container stand 12 may have the first support 16 and the second support 18 at an angle of about 45 degrees relative to the base 20. Furthermore, the angle formed between the first support 16 or the second support 18 and the base may be between about 0-45, 45-90, 90-135 and 135-180. The angle between the first support 16 and the base 20 and the second support 18 and the base may be similar or different and range independently from 0-45, 45-90, 90-135 and 135-180 degrees. Additionally, the container stand 12 may be designed to allow the angle to be adjusted in a single unit, thus allowing one pivotable container holder 10 to be used for a variety of different applications. Additionally, the first support 16 and the second support 18 may be extendable to accommodate containers (not shown) of different heights. The first support 16 and/or the second support 18 may be constructed in part or entirely of a flexible material that allows the first support 16 and/or the second support 18 to be positioned at any angle.

The container stand 12 may be designed to accommodate a variety of mounting devices. In one embodiment, a first aperture 22 extends through the first support 16. The first aperture 22 allows a pin (not shown) to be inserted to secure a container holder (not shown). In another embodiment, the first aperture 22 may have a first notch 28 extending through at least a portion of the first support 16. The first notch 28 may be designed to receive a pin or tab (not shown). The pin may be a screw, a peg, a cotter pin, a bolt, a rod, a tie, a plastic strip, a sting, etc. Some embodiments may have a first aperture 22, which is made up of a series of two or more apertures spaced along the first support 16 to accommodate a variety of different mounting positions for the container holder (not shown).

Other embodiments may have a first notch 28, which is made up of a series of notches spaced along the first support 16 to accommodate a variety of different mounting positions for the container holder (not shown). Embodiments of the container stand 12 that have more than one support (not shown) may also include similar mounting device, different mounting device, or a combination thereof. For example, in one embodiment, the container stand 12 may have, a first support 16 having a first aperture 22 and a second support 18 having a second aperture 24. In another embodiment, the container stand 12 may have a first support 16 having a first notch 28 and a second support 18 having a second notch 30. In yet another embodiment, the container stand 12 may have a first support 16 having a first notch 28 and a second support 18 having a second aperture 24.

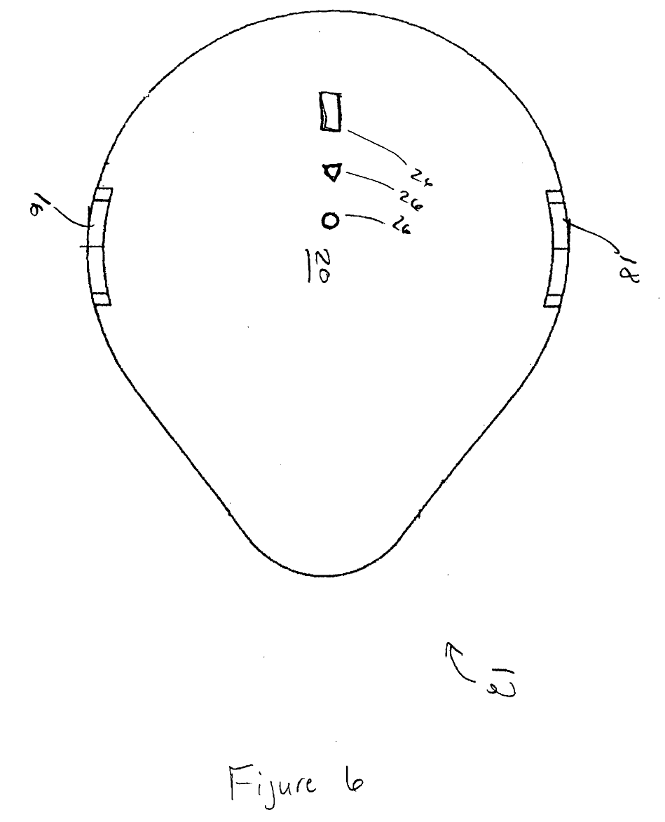

With respect to FIG. 6, a top view of another embodiment of the device shown in FIG. 1. The container stand 12 has a first support 16 and a second support 18 that extend generally perpendicular to the base 20. The base 20 has generally an elliptical shape; however, the base 20 may take different shapes depending on the desired application. The base 20 may be circular, square, rectangular, egg shaped, hexagonal, polygonal or any other shape. The base 20 may also be sized differently as needed. Alternatively, the base 20 may be adjustable (e.g., slidable, lockable or attachable) in width to accommodate different size containers (not shown). Generally, the base 20 is proportional to the container (not shown); however, the base 20 may be larger or smaller in comparison to the container (not shown), allowing the container stand to remain stable on a variety of surfaces.

One or more stops 26 are disposed on or about the base 20, wherein the one or more stops 26 impede the motion of the container (not shown). The one or more stops 26 may be generally perpendicular to the base 20 and extend to a height that is necessary to secure the container (not shown). The one or more stops 26 may be individually of different sizes and shapes, e.g., bar, square, rectangle, circle, cone, oval, triangular or any other shape. Furthermore, the one or more stops 26 may include a mechanism (e.g., plastic tab, magnetic portion, barb or a combination thereof) that may interact with the container (not shown) or the container holder (not shown).

The container stand 12 has a first support 16 and a second support 18 that extend generally perpendicular to the base 20, wherein the first support 16 and the second support 18 may be of different lengths, widths or a combination thereof, thus, allowing placement of the container stand 12 on a surface that is angled to some degree, while retaining a level position for the container (not shown).

Furthermore, the base 20 may be of different dimensions and allow the first support 16 and the second support 18 to be separated by different distances to accommodate different containers (not shown). The base 20 may also be of a uniform thickness or a thickness that varies form one region (not shown) to another region (not shown). The base 20 may also include a non-stick coating to allow easy cleanup of material. The base 20 may also include a mechanism for attaching the base 20 to a surface (not shown), e.g., a hook and loop attachment, tape, glue, screw, hole, nail, weights, clamp or a combination thereof.

Additionally, the container stand 12 may include a first base (not shown) attached the first support 16 and a second base (not shown) attached to a second support 18. A dual base container stand (not shown) will accommodate surfaces of different topography. In addition, the container stand 12 may have more than two supports each with a separate base 20. The bases may be of similar or different dimensions and the supports may be adjustable to provide stability on different topographies.

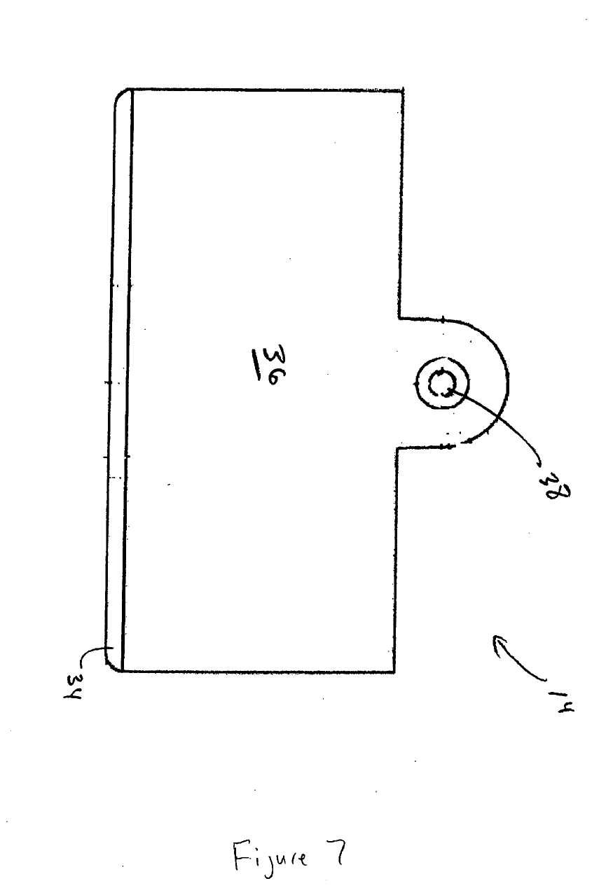

FIG. 7 is a side view of another embodiment of the container holder 14 of the device shown in FIG. 1. The container holder 14 is an open top container that includes a container holder bottom 34 and a container holder sidewalls 36 extending from the container holder bottom 34. As shown in FIG. 7, the container holder bottom 34 provides a generally flat bottom surface. Although, other container holder bottoms 34 may be used including a concave or convex surface. The container holder sidewalls 36 may be penetrated by a container holder aperture 38.

The container holder sidewalls 36 form a structure that is generally circular in shape and approximately the size of an aerosol container (not shown). The container holder sidewalls 36 may be of different shapes, e.g., square, rectangular, circular, elliptical, polygonal, triangular or a combination thereof. The container holder 14 may also be of different sizes to accommodate containers of different sizes. Furthermore, the shape of the container holder 14 may differ from the shape of the container (not shown) itself. For example, a round container may be fitted into a triangular or rectangular container holder 14. The container holder sidewalls 36 may extend to different heights from the container holder bottom 34 depending on the particular application, e.g., between 0.5 and 6 inches and between 6 inches and 2 feet. The container holder sidewalls 36 may also have a contoured shape. The container holder sidewalls 36 may also have an extension to accommodate the container holder aperture 38.

The container holder sidewalls 36 may be penetrated by one or more container holder apertures 38. The container holder aperture 38 may be of different sizes to accommodate a variety of different securing mechanisms, e.g., bolts, pins, tabs or the like. Alternatively, the container holder sidewalls 36 may have a first protrusion 42 and a second protrusion 44 extending from the container holder sidewalls 36, whereby the container holder 14 may be attached to a base (not shown). Alternatively, the container holder sidewalls 36 may have a first protrusion 42 extending from the container holder sidewalls 36 and a container holder aperture 38 extending from the container holder sidewalls 36.

The container holder 14 may be contracted from a plastic material, however the container holder 14 may also be constructed from variety of materials, e.g., metal, alloy, plastic, composite materials, carbon fiber, ceramics, glass, rock, stone, wood or a combination thereof. Additionally, the container holder 14 may be made from a malleable material (e.g., rubber, plastic, latex, vinyl, polymers or combinations thereof) that may conform to the container (not shown), thus allowing the container holder 14 to conform to a variety of containers (not shown).

The container holder 14 may include one or more securing mechanisms (not shown) to secure the container within the container holder 14. The one or more securing mechanisms (not shown) may be a grove, a notch or series of notches, a snap ring or similar mechanism known in the art. The container holder 14 may also include an insert (not shown) that conforms to the shape of the container holder 14, while accommodating the container (not shown), thus allowing the container to fit a variety of container holders 14.

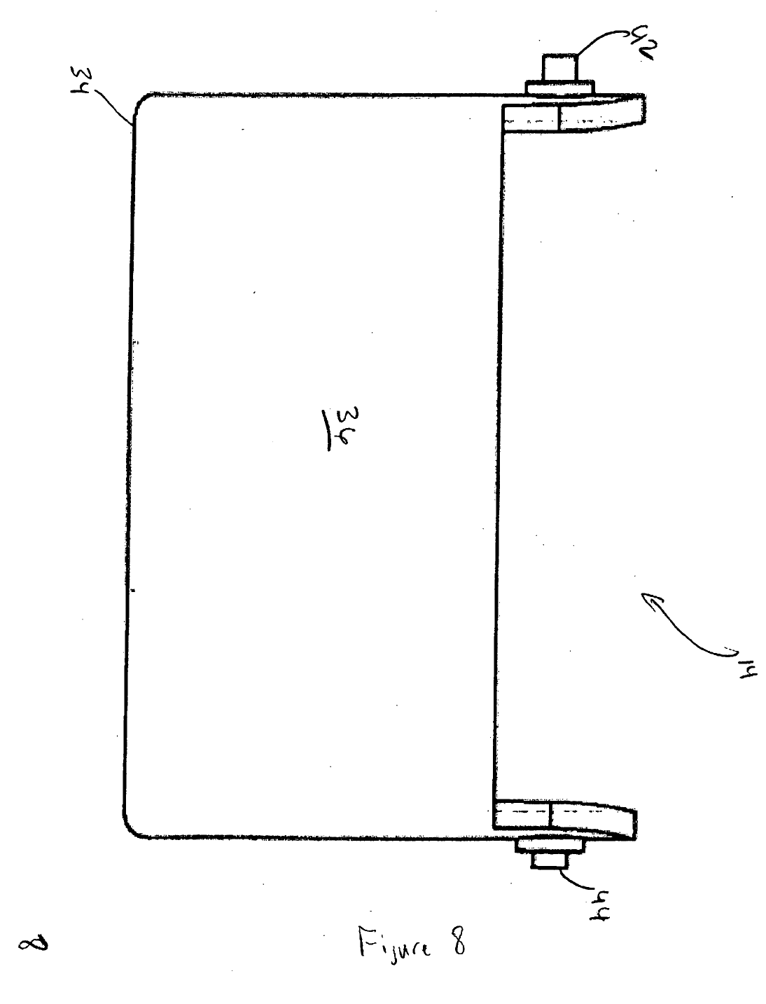

FIG. 8 is a front view of another embodiment of the container holder 14 portion of the device shown in FIG. 1. The container holder 14 is an open top container that includes a container holder bottom 34 and a container holder sidewalls 36 extending from the container holder bottom 34. The container holder sidewalls 36 may have a first protrusion 42 and a second protrusion 44 extending from the container holder sidewalls 36, whereby the container holder 14 may be attached to a base (not shown).

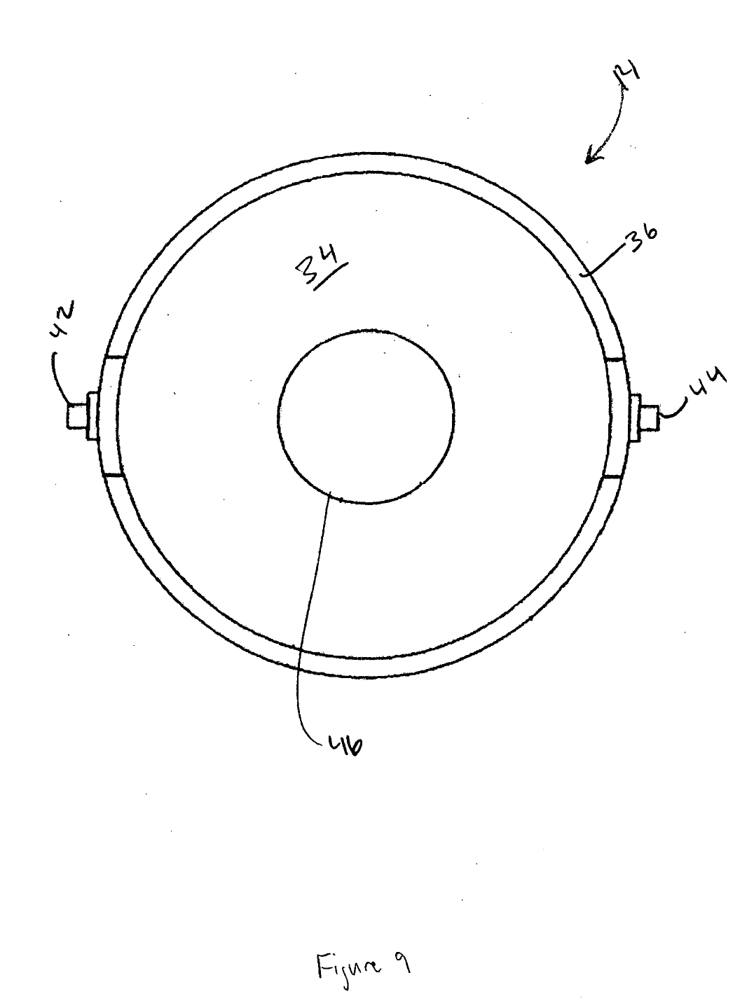

FIG. 9 is a top view of another embodiment of the container holder portion of the device shown in FIG. 1. The container holder 14 is an open top container that includes a container holder bottom 34 and a container holder sidewalls 36 extending from the container holder bottom 34. The container holder bottom 34 provides a generally flat bottom surface. Although, other embodiments may use container holder bottoms 34 that are concave or convex. The container holder bottom 34 may also includes a container holder bottom aperture 46. The container holder bottom aperture 46 may be of different sizes (e.g., 0.25 to 1 inches or even 1 inch or larger) and shapes (e.g., oval, circular rectangular, square, polygonal or similar shapes). Other embodiments, of the present invention include one or more container holder bottom apertures 46. The container holder sidewalls 36 may have a first protrusion 42 and a second protrusion 44 extending from the container holder sidewalls 36, whereby the container holder 14 may be attached to a container stand (not shown).

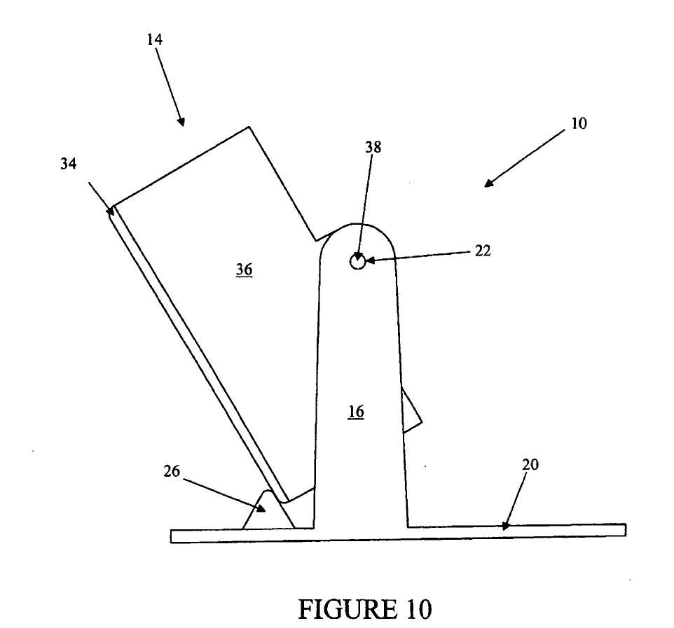

With reference to FIG. 10, in accordance with the present invention is shown in a side view and includes the pivotable container holder 10 having a container stand 12 and a container holder 14. The container stand 12 includes a first support 16 extending generally perpendicular from the base 20. The first support 16 has a first aperture 22 extending through the first support 16. In other embodiments, the first aperture 22 may extend partially through the first support 16. One or more stops 26 are disposed on or about the base 20, wherein the one or more stops 26 impede the motion of the container holder 14.

The container holder sidewalls 36 form a structure that is generally circular in shape and approximately the size of an aerosol container (not shown). The container holder sidewalls 36 may form different shapes, e.g., square, rectangular, circular, elliptical, triangular or a combination thereof. The container holder 14 may also be of different sizes to accommodate containers of different sizes. Furthermore, the shape of the container holder 14 may differ from the shape of the container (not shown) itself. For example, a round container may be fitted into a triangular or rectangular container holder 14. The container holder sidewalls 36 may be of a different height from the container holder bottom 34 depending on the particular application, e.g., between 0.5 and 6 inches and between 6 inches and 2 feet. The container holder sidewalls 36 may also have a contoured shape. The container holder sidewalls 36 may also have an extension to accommodate the container holder aperture 38.

In one embodiment, the first aperture 22 of the first support 16 aligns with the container holder aperture 38 of the container holder sidewalls. The container holder aperture 38 and the first aperture 22 may be of different sizes to accommodate a variety of different securing mechanisms, e.g., bolts, pins, tabs or the like. Alternatively, the container holder sidewalls 36 may have a first protrusion 42 extending from the container holder sidewalls 36 and aligning with the first aperture 22 of the first support 16 to secure the container stand 12 and the container holder 14. In another embodiment, the container holder sidewalls 36 may have a first protrusion 42 and a second protrusion 44 extending from the container holder sidewalls 36 and aligning with the first aperture 22 and the second aperture 24 respectively of the container stand 12 and securing the container stand 12 and the container holder 14. In another embodiment, the container holder 14 has container holder aperture 38 and a first protrusion 42 that align with a first aperture 22 of the container stand 12 and a protrusion container stand (not shown) to connect the container stand 12 and the container holder 14.

In another embodiment, the first aperture 22 has a first notch 28 extending through at least a portion of the first support 16 and a second notch 30 extending through at least a portion of the second support 18. The first notch 28 and second notch 30 are designed to receive the first protrusion 42 and a second protrusion 44 respectively extending from the container holder sidewalls 36, thus securing the container stand 12 and the container holder 14.

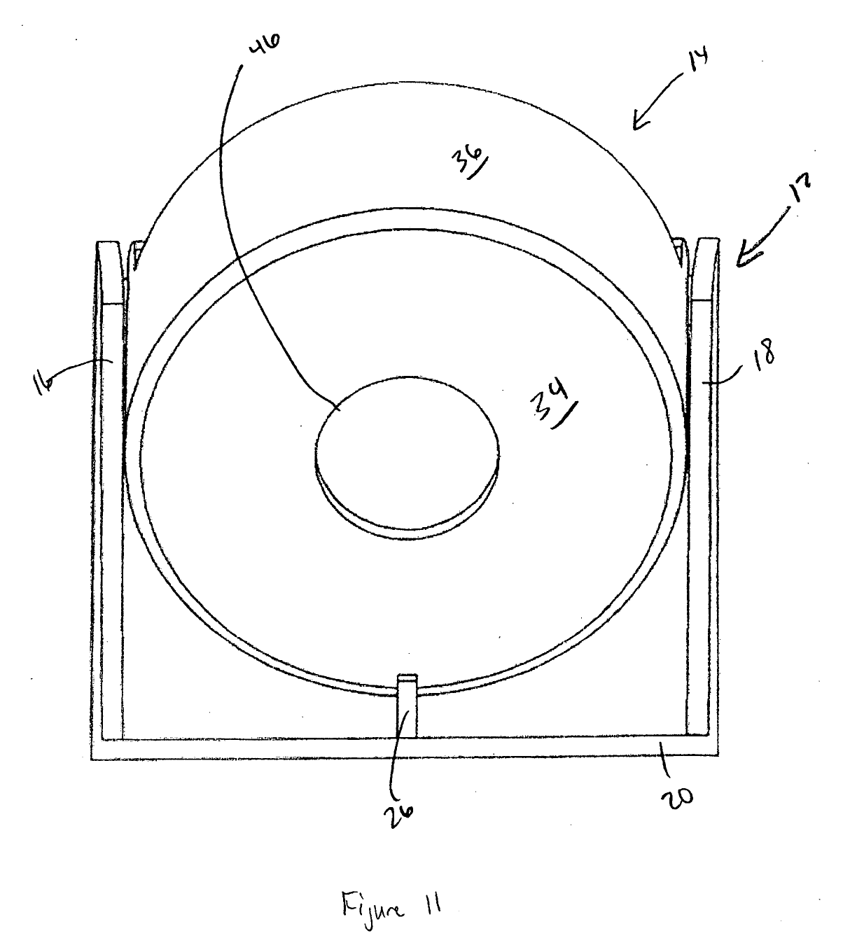

FIG. 11 is a back view of one embodiment of the device shown in FIG. 1. The container stand 12 includes a first support 16 and a second support 18 extending generally perpendicular from the base 20. One or more stops 26 are disposed on or about the base 20, wherein the one or more stops 26 impede the motion of the container holder 14. The container holder 14 is an open top container that includes a container holder bottom 34 and a container holder sidewall 36 extending from the container holder bottom 34. The container holder bottom 34 provides a generally flat bottom surface. Although, other container holder bottoms 34 may be concave or convex. The container holder bottom 34 also includes a container holder bottom aperture 46. The container holder bottom aperture 46 may be of different sizes (e.g., 0.25 to 1 inches or even 1 inch or larger) and shapes (e.g., oval, circular rectangular, square, polygonal or similar shapes). Other embodiments, of the present invention include more than one container holder bottom apertures 46. The container holder sidewalls 36 may be connected to the first support 16 and the second support 18 extending generally perpendicular from the base 20.

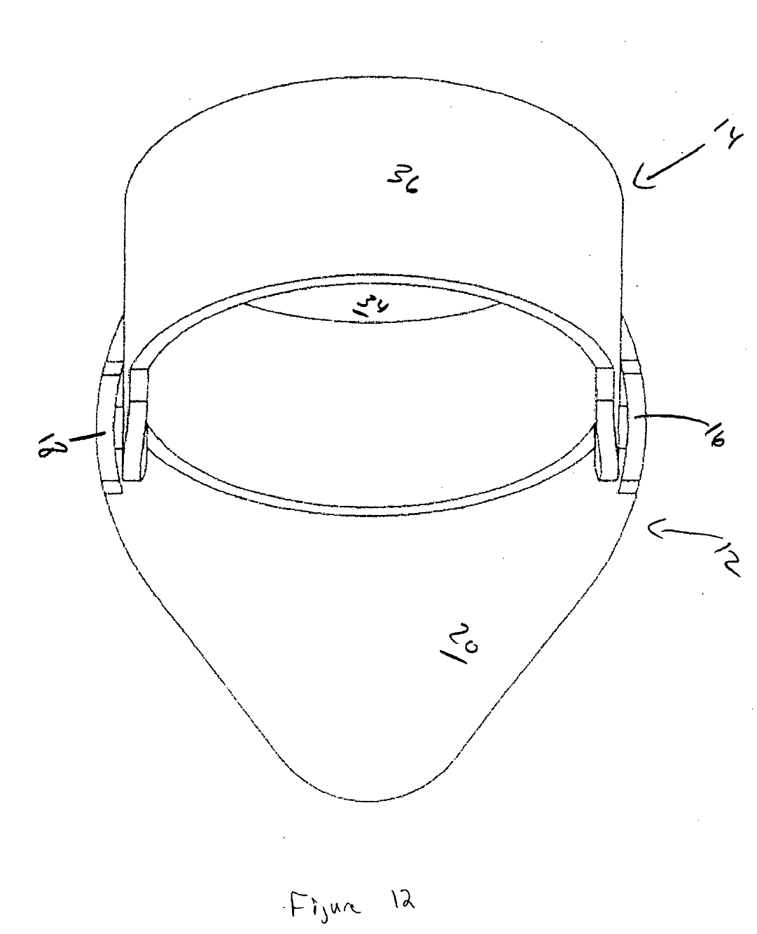

FIG. 12 is a top view of one embodiment of the device shown in FIG. 1 that includes the container stand 12 and the container holder 14. The container stand 12 includes a first support 16 and a second support 18 extending generally perpendicular from the base 20. The container holder 14 is an open top container that includes a container holder bottom 34 and one or more container holder sidewalls 36 extending from the container holder bottom 34. The container holder bottom 34 provides a generally flat bottom surface. Although, other container holder bottoms 34 may also include a concave or convex surface. The container holder sidewalls 36 are connected to the first support 16 and the second support 18 extending generally perpendicular from the base 20.

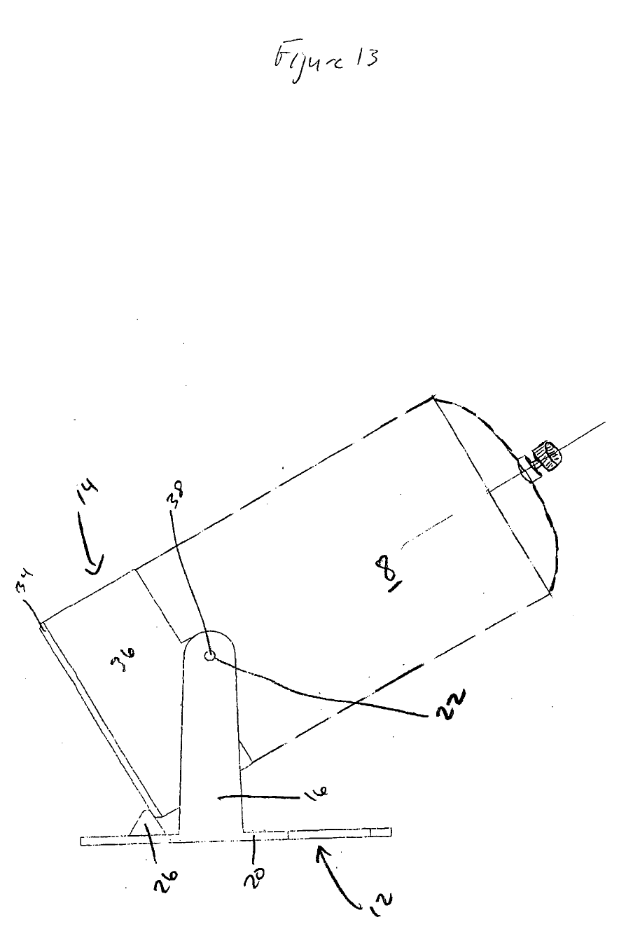

With reference to FIG. 13, in accordance with the present invention is shown and includes a container 8, a container stand 12 and a container holder 14 in a side view. The container stand 12 includes a first support 16 extending generally perpendicular from the base 20. The first support 16 has a first aperture 22 extending through the first support 16. In other embodiments, the first aperture 22 may extend partially through the first support 16. One or more stops 26 are disposed on or about the base 20, wherein the one or more stops 26 impede the motion of the container holder 14 and the container 8, e.g., aerosol, pressurized or the like.

The container holder 14 is an open top container that includes a container holder bottom 34 and one or more container holder sidewalls 36 extending from the container holder bottom 34. The container holder bottom 34 provides a generally flat bottom surface; however, other container holder bottoms 34 may be used including a concave, convex or a combination thereof. The one or more container holder sidewalls 36 may be penetrated by a first protrusion 42, whereby the container holder 14 may be connected to the container stand 12.

The container holder sidewalls 36 form a structure that is generally circular in shape and approximately the size of a container 8. The container holder sidewalls 36 may form different shapes, e.g., square, rectangular, circular, elliptical, triangular or a combination thereof. The container holder 14 may also be of different sizes to accommodate containers 8 of different sizes, e.g., between about 4 to 6 ounces, 6 to 12 ounces, 12 to 16 ounces and 16 ounces and larger containers.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations can be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1. A method of deodorizing an enclosure comprising the steps of:
inserting a container comprising a deodorizer into a container holder having a container holding portion connected to one or more supports extending generally perpendicular from a generally planar base and one or more stops extending from the generally planar base, wherein the one or more stops restrict the movement of the container;
adjusting the container holder for maximum dispersion of the deodorizer; and
activating the container to dispense the deodorizer.

2. The method of claim 1, wherein the one or more supports further comprises one or more apertures and the container holding portion further comprises one or more tangentially extending tabs, wherein the one or more aperture receive pivotably the one or more tangentially extending tabs.

3. The method of claim 1, wherein the container holding portion comprises a container aperture formed by a cylindrical wall and a container holder bottom connected to the cylindrical wall at a lower end thereof.

4. The method of claim 1, wherein the container aperture is marginally larger than the container.

5. The method of claim 1, wherein one or more pins connect pivotably the container holding portion and the one or more supports.

6. The method of claim 1, wherein the step of adjusting the container holder comprises contacting the one or more stops and a portion of the container holder, whereby the angle of the container holding portion relative to the generally planar base is adjusted, contacting the one or more stops and at least a portion of the container, whereby the angle of the container relative to the generally planar base is adjusted, rotating the container within the container holding portion or a combination thereof.

7. A pivotable container holder comprising:
a generally planar base;
one or more supports extending generally perpendicular from the generally planar base;
a container holding portion comprising a container aperture for fitting frictionally a container, wherein the container holder portion is attached pivotably to one or more of the one or more supports; and
one or more stops extending from the generally planar base, wherein the one or more stops restrict the movement of the container.

8. The container holder of claim 7, wherein the generally planar base is larger than the container holding portion.

9. The container holder of claim 7, wherein the container is an aerosol container, a pump container, a spray container, a pressurized container, a container and fan combination, a container holding a solid, a container holding a liquid, a container holding a gel or a combination thereof.

10. The container holder of claim 7, wherein the one or more supports further comprise one or more apertures and the container holding portion further comprises one or more tangentially extending tabs, wherein the one or more apertures receive pivotably the one or more tangentially extending tabs.

11. The container holder of claim 7, wherein the container aperture is formed by a cylindrical wall.

12. The container holder of claim 11, further comprising a container holder bottom connected to the cylindrical wall at a lower end thereof.

13. The container holder of claim 12, wherein the container holder bottom of the container holding portion comprises one or more holes pass through the floor for drainage.

14. The container holder of claim 7, wherein the one or more stops have a individual profile that are triangular, round, square, oval, rectangular, polygonal or a combination thereof.

15. The container holder of claim 7, wherein the one or more stops position the container at one or more different angles between the container and the generally planar base.

16. The container holder of claim 15, wherein the angle formed between the generally planar base and the container holding portion is between about 0 and 90 degrees.

17. The container holder of claim 7, wherein the one or more stops contact at least a portion of the container holding portion or the container, thereby restricting the angle formed between the container and the generally planar base.

18. A method of delivering an agent into an enclosure comprising the steps of:
inserting a container into a container holder having a container holding portion connected to one or more supports extending generally perpendicular from a generally planar base and one or more stops extending from the generally planar base, wherein the one or more stops restrict the movement of the container;
adjusting the container to the desired position; and
activating the container, whereby the agent is dispersed.

19. The method of claim 18, wherein the one or more supports further comprises one or more apertures and the container holding portion further comprises one or more tangentially extending tabs, wherein the one or more aperture receive pivotably the one or more tangentially extending tabs.

20. The method of claim 18, wherein the enclosure comprises a car, a house, a building, an office, a closet, a room, an attic, a crawl space, a cab, a tool box, a refrigerator, a freezer, a trailer, a mobile home, a bathroom, a bedroom, a garage, a warehouse, a storage unit, a clubhouse, a pantry, a laundry, a shed, a kitchen, a toy box, trunk or a combination thereof.
